(19) United States
(12) Patent Application Publication
(10) Pub. No.: US 2005/0132689 A1
(43) Pub. Date: Jun. 23, 2005

(54) Header for mowing stalk crops

(75) Inventor: Alfons Resing, Stadtlohn (DE)

Correspondence Address: Jimmie R. Oaks;Patent Department, DEERE & COMPANY, One John Deere Place, Moline, IL, 61265-8098, US

(73) Assignee: Maschinenfabrik Kemper GmbH & Company KG.

(21) Appl. No.: 10/991,162

(22) Filed: Nov. 16, 2004

(30) Foreign Application Priority Data
Dec. 17, 2003 (DE) 103 59 201.6

(51) Int. Cl. A01D 45/02

(52) U.S. Cl. 56/51

(57) ABSTRACT

A header for mowing stalk crops includes an inner pair of mowing and feed devices located on opposite sides of, and adjacent to, the longitudinal mid-plane of the header, with the mowing and feed devices rotating about an approximately vertical axis. A pair of deflecting conveying elements receive cut plants from the inner pair of mowing and feed devices and transfer the plants to the feed channel of a forage harvester, that carries the header at its front. A pair of outer mowing and feed devices are also mounted for rotation about respective approximately vertical axes and transfer cut plants to the pair of inner mowing and feed devices. The outer pair of mowing and feed devices are respectively disposed rearward of the inner pair of mowing and feed devices.

### FIELD OF THE INVENTION

The invention relates to a header for mowing stalk crops which includes inner mowing and feed devices adjacent to the longitudinal mid-plane of the header and rotating about an approximately vertical axis, with the devices which cut plants entering the working area and transport the cut plants to the deflecting conveying elements, which transfer the plants to the feed channel of a forage harvester, and includes outer mowing and feed devices, which rotate about an approximately vertical axis, cut the plants entering the range of action, and transfer the cut plants to the inner mowing and feed devices.

### BACKGROUND OF THE INVENTION

Headers are used in agriculture to cut stalk crops, for example, corn plants, from the soil of a field and to convey them to the harvester carrying the header, with the harvester including a chopper drum arrangement for chopping the plants into pieces which are discharged into a container on a trailer. These headers are often equipped with several mowing and feed devices, arranged laterally adjacent to one another and operating independently of rows, in the form of drums rotating around a vertical axis with notches distributed around their periphery, in which the plant stalks are taken up, as well as mowing disks arranged below the drums, which are used to cut the plant stalks from the soil.

An example of a header equipped with several mowing and feed devices is disclosed in EP 0 508 189 A. The mowing and feed devices, adjacent to the longitudinal mid-plane, transfer the plants they cut to the deflecting conveying elements, which transfer the plants to the feed channel of the forage harvester carrying the header. The leading edges of all mowing and feed devices are disposed on a straight line extending transverse to the forward direction. It is disadvantageous that the center of gravity of the machine is relatively far in front, particularly when relatively large mowing and feed devices are used, which in each case can simultaneously take up two rows of plants sown at a distance of 75 cm.

If the working width of the header is increased (see EP 0 760 200 A), the outer mowing and feed devices and the outer stalk dividers of the header are removed very far from the midpoint between the wheels of the forage harvester, not only in the transverse direction but also in the forward direction. This distance results in great movements at the anterior points of the stalk dividers even with a minor turning of the steering of the self-propelled forage harvester. If there are plants in the immediate vicinity of the points of the stalk dividers, these are abruptly knocked over at maximum angles of turn and perhaps not picked up by the header. Very long stubble results, which gives an untidy impression of the harvested field.

DE 40 02 344 A shows a header for harvesting corn, in which four conveyor drums are disposed laterally adjacent to one another. Mowing and conveyor drums are disposed ahead of the conveyor drums. A cross-feed screw conveys the harvested crop to the feed channel of the forage harvester. The plants are thereby cut by the mowing and feed devices and transferred to the conveyor drums and finally to the cross-feed screw. Although the outer conveyor drums are disposed rearward of the inner conveyor drums, the center of gravity of the machine is relatively far in front because of the use of the cross-feed screw and the conveyor drums.

Another header is shown in DE 38 28 293 C. It comprises rather large outer mowing and conveyor drums and rather small inner mowing and conveyor drums on both sides of the longitudinal mid-plane. The axes of rotation of the outer mowing and conveyor drums are slightly displaced rearward relative to the axes of rotation of the inner mowing and conveyor drums. The outer mowing and conveyor drums take the incoming material also from the inner mowing and conveyor drums to a cross-feed screw, which conveys it to the feed channel of the forage harvester. In this machine as well, the cross-feed screw results in a large overall length of the header in the forward direction.

The problem underlying the invention is that of providing a header for harvesting stalk plants which has a center of gravity which is as far back as possible for a given working width of the header.

### SUMMARY OF THE INVENTION

According to the present invention, there is provided a header equipped with an improved arrangement of mowing and feed devices for delivering cut crop for further processing in a harvester carrying the header.

The header has, on both sides of a longitudinal mid-plane, inner and outer mowing and feed devices, which are constructed from a cutting disk and conveying disks disposed above these with recesses distributed along their periphery for taking up plant stalks. The outer mowing and feed devices transfer the plants harvested by them to the inner mowing and feed devices, which function in this respect as a transferring element. The inner mowing and feed devices take the plants to deflecting conveying elements, which, for example, are made as drums, rollers, or screws with any desired axis of rotation and convey the plants into the feed channel of the forage harvester. As taught by the invention, the leading edge of the outer mowing and feed device is displaced rearward relative to the leading edge of the inner mowing and feed device.

The header of the invention is constructed relatively short in the forward direction, because a cross-feed screw is superfluous due to the use of the inner mowing and feed devices for transferring the plants entering from the outer mowing and feed devices to the center of the header. Because the outer mowing and feed devices are displaced rearward, the center of gravity of the machine is displaced rearward, which has a favorable effect on the handling and the bottom bearing strength of a field harvester carrying the header. The header can also be steered more easily, because the distance between a center location between the front wheels of the forage harvester and the outer stalk dividers is shortened compared to the distance between such location and leading edges of the mowing and feed devices of known headers.

The diameters of the mowing and feed devices of the entire header are preferably the same, so that many similar parts are used. It makes it possible preferably to harvest two rows sown at a distance of 75 cm with a single mowing and feed device. Machines of this type make it possible to harvest eight rows of plants simultaneously. The mowing and feed devices can also have different diameters, however. If it is desired to increase the working width further, more than two mowing and feed devices are provided on both sides of the machine, with the leading edges of each of the central mowing and feed devices being displaced rearward relative to the next inner mowing and feed devices and forward relative to the next outer mowing and feed devices. A V shape then results in the top view.

Specifically, the leading edges of the outer mowing and feed devices can be located approximately at a transverse line passing through the centers of the axes of rotation of the inner mowing and feed devices. It is achieved thereby that the plants, harvested by the outer mowing and feed devices, are transported almost only in a lateral direction to the deflecting conveying elements. Their transport path is thereby relatively short.

To drive the outer mowing and feed devices, there is a cross shaft, the imaginary prolongation of which intersects the axes of rotation of the outer mowing and feed devices. The cross shaft is driven by the forage harvester. In this way, right angle gears to drive the outer mowing and feed devices become unnecessary.

### BRIEF DESCRIPTION OF THE DRAWINGS

An exemplary embodiment of the invention, described in greater detail below, is presented in the drawings.

FIG. 1 is a top view of a header of the invention for harvesting stalk crops in schematic diagram.

FIG. 2 is the drive section of the mowing and feed devices of the header of FIG. 1.

### DESCRIPTION OF THE PREFERRED EMBODIMENT

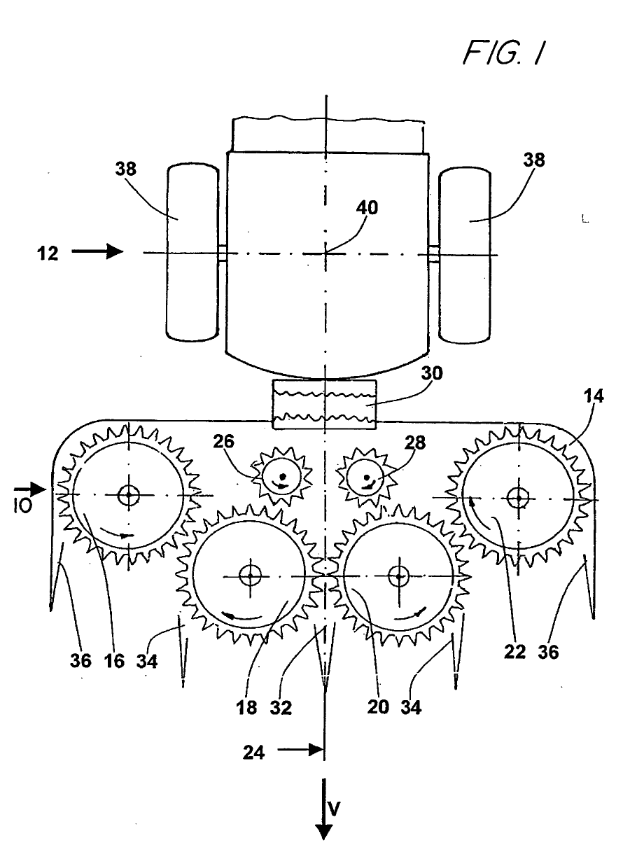

FIG. 1 shows a schematic top view of a header 10 of the invention for mowing stalk crops, for example, corn. The header 10 is mounted on the front end of a self-propelled forage harvester 12 and includes a frame 14 to which four mowing and feed devices 16, 18, 20, 22 are attached laterally next to each other. The mowing and feed devices 16, 18, 20, 22 are equipped in a manner known per se with cutting disks rotating around the vertical axis and likewise rotating feed disks disposed above these, with notches distributed around their periphery to take up the stems of the cut plants. Mowing and feed devices 16-22 of this type are disclosed in detail in EP 0 099 527 A, the content of which is incorporated into the present documents by reference.

The diameter of the mowing and feed devices 16-22 is approximately 1.5 m, so that each of them can take up two rows of plants grown at a distance of 75 cm. The header 10 can thereby harvest eight rows simultaneously.

The direction of rotation of the inner mowing and feed devices 18, 20, adjacent to the longitudinal mid-plane 24 of the header 10, is such that the cut plants are first conveyed outward and then rearward. At backs of the devices, the plants are taken up by drum-like deflecting conveying elements 26, 28 with approximately vertical, but slightly forward inclined axes of rotation, which take the plants rearward and upward into the feed channel 30 of the forage harvester 12. The header 10 is constructed symmetric to the longitudinal mid-plane 24.

The outer mowing and feed devices 16, 22 turn in a direction opposite to the inner mowing and feed devices 18, 20, i.e., they convey the plants in the direction of the longitudinal mid-plane 24. Approximately at its point next to the inner mowing and feed devices 18, 20, the plants are transferred from the outer mowing and feed devices 16, 22 and then (supported by clearers or strippers disposed there, which are not shown in the drawings) to the inner mowing and feed devices 18, 20, which then convey them to the deflecting conveying elements 26, 28.

Stalk dividers 32, 34, 36 are disposed between adjacent mowing and feed devices 16-22 and on the outsides of the outer mowing and feed devices 16, 22.

As taught by the invention, the outer mowing and feed devices 16, 22 are displaced rearward relative to the inner mowing and feed devices 18, 20 opposite to the forward direction. The leading edges of the outer mowing and feed devices 16, 22 are located on a horizontal line, which runs transverse to the forward direction V and approximately through the axes of rotation of the inner mowing and feed devices 18, 20. This displacement rearward has the following advantages: (1) the center of gravity of the header 10 lies farther back than in headers, the mowing and feed devices of which all lie on a straight line. The transport path of the plants from the outer mowing and feed devices 16, 22 to the deflecting conveying elements 26, 28 is shortened, because a shorter path is traveled in the backward direction. With the outer mowing and feed devices 16 and 22, the outer stalk dividers 36 are also displaced rearward. The header 10 thus has a shorter distance between the front points of the outer stalk dividers 36 and the midpoint 40 between the front wheels 38 of the forage harvester 12. The advantageous result is that the header 10 can be steered more easily over a field and especially turned, because the movement of the tips of the stalk dividers 36 is more easily visible.

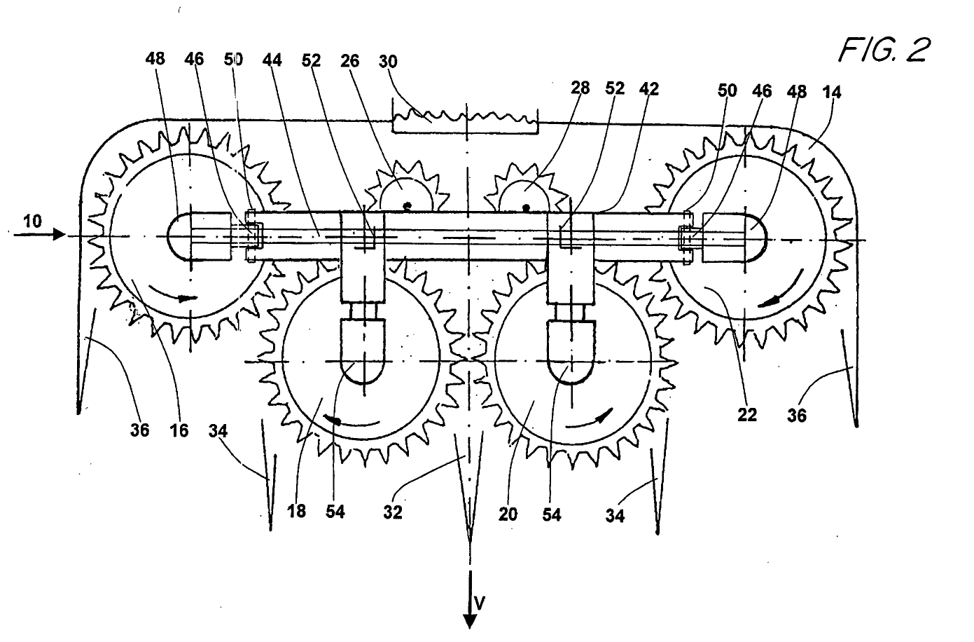

Part of the drive section of the header 10 is shown in FIG. 2. A cross shaft 44, which is driven by (not depicted) U-shafts and right angle gears of forage harvester 12, extends with a hollow section 42 extending transverse to the forward direction V. It would also be conceivable not to use the hollow section 42. The cross shaft 44 runs along to the straight line connecting the axes of rotation of the outer mowing and feed devices 16, 22. The drives 48 of the outer mowing and feed devices 16, 22 are connected with the cross shaft 44 by means of the claw couplings 46. The claw couplings 46 make it possible to tilt the outer mowing and feed devices 16, 22 around the horizontal axes 50, running in the forward direction, in a transport position, in which the outer mowing and feed devices 16, 22 form the vertical legs of a “U,” whereby the horizontal parts of the “U” are formed by the untilted mowing and feed devices 18, 20. The inner mowing and feed devices 18, 20 are driven by the drive shaft 44 via the assigned right angle gears 52 and drives 54, which are located in the forward direction V ahead of the cross drive 44. The outer mowing and feed devices 16, 22, displaced rearward, thereby make possible a simplified drive system, because the right angle gears 52 assigned to them are not necessary.

Having described the preferred embodiment, it will become apparent that various modifications can be made without departing from the scope of the invention as defined in the accompanying claims.

1. In a header for mowing stalk crops including an inner pair of mowing and feed devices located on opposite sides of, and adjacent to, a longitudinal mid-plane of the header and each rotating about an approximately vertical axis, said inner pair of mowing and feed devices being located forward of, and adjacent to, a pair of deflecting conveying elements to which plants cut by said inner pair of mowing and feed devices are delivered, and a pair of outer mowing and feed devices which are each mounted for rotation about an approximately vertical axis and being operable for cutting plants and transferring them to said inner pair of mowing and feed devices, the improvement comprising: said outer pair of mowing and feed devices having leading edges disposed along a first transverse line spaced rearward of a second transverse line disposed tangent to leading edges of said inner pair of mowing and feed devices.

2. The header, as defined in claim 1, wherein all of said mowing and feed devices of said inner and outer pairs of mowing and feed devices are equal in diameter.

3. The header, as defined in claim 1, wherein said first transverse line runs approximately through the axes of rotation of the inner mowing and feed devices.

4. The header, as defined in claim 1, wherein said outer pair of mowing and feed devices are respectively connected by respective couplings to opposite ends of a cross shaft located on a connecting straight line through the axes of rotation of said outer pair of mowing and feed devices.

5. The header, as defined in claim 4, wherein said respective couplings at opposite ends of said cross shaft are separable couplings; and said separable couplings each establishing a horizontal pivot axis extending fore-and-aft in perpendicular relationship to said cross shaft so that said pair of outer mowing and feed devices may be pivoted around said horizontal pivot axes between lowered working positions and raised transport positions.

6. The header, as defined in claim 1, wherein a pair of stalk dividers are respectively disposed outside said pair of outer mowing and feed devices; and further stalk dividers being respectively located between adjacent ones of said outer and inner pairs of mowing and feed devices at locations spaced forward of said pair of stalk dividers.
